(19) United States
(12) Patent Application Publication
(10) Pub. No.: US 2009/0241850 A1
(43) Pub. Date: Oct. 1, 2009

(54) Pet Waste Collection System

(75) Inventors: Leslie L. Campbell, Lake Worth, FL (US); John Silvestri, Scottsdale, AZ (US); Maidam Krishnachaitanya, Hyderabad (IN); Ying Xiong, Miramar, FL (US)

Correspondence Address: King & Spalding LLP, 401 Congress Avenue, Suite 3200, Austin, TX, 78701, US

(73) Assignee: APPLICA CONSUMER PRODUCTS, INC.

(21) Appl. No.: 12/363,235

(22) Filed: Jan. 30, 2009

Related U.S. Application Data
(60) Provisional application No. 61/025,611, filed on Feb. 1, 2008.

(51) Int. Cl. A01K 29/00; A01K 1/01; A01K 1/015

(52) U.S. Cl. 119/164; 119/161; 119/163

(57) ABSTRACT

A pet waste collection system comprising a frame, a mounting bracket, a spool, and a sensor. The frame defines a floor with a first end and a second end. The floor may be configured to receive waste from a pet. The mounting bracket may be located on the first end of the floor and configured to receive a wrapper cartridge. The spool may be located on the second end of the floor and configured to allow a film to be drawn from the wrapper cartridge across the floor and to roll the film around the spool. The sensor is configured to detect the presence of pet waste at the film proximate the floor.

### RELATED PATENT APPLICATION

This application claims the benefit of U.S. Provisional Application No. 61/025,611, filed Feb. 1, 2008 and entitled “PET WASTE COLLECTION SYSTEM.”

### TECHNICAL FIELD

The present invention relates to waste handling systems and, more particularly, systems for pet waste collection.

### BACKGROUND OF THE INVENTION

Cats are often trained to use a litter box for elimination of both liquid and solid wastes. Use of a litter box may provide a sanitary option for cats that are not allowed to go outdoors. In fact, some studies suggest that cats kept strictly indoors have a markedly increased life expectancy when compared to cats that are allowed to go outdoors. Basic litter boxes, while allowing a cat to be kept inside, may be described as smelly, messy, and/or dirty by some cat owners. Self-cleaning litter boxes may provide a solution to these complaints. For example, self-cleaning litter boxes are disclosed in U.S. Pat. Nos. 5,048,465 (Carlisi), 5,226,388 (McDaniel), 5,477,812 (Waters), 6,082,302 (Thaler), and 6,378,461 (Thaler). The systems described in the above-identified patents typically use a comb or a rake to move through a litter box and discharge any clumps.

As mentioned above, a variety of systems are available for cat waste disposal. However systems for use with other pets and/or animals are less well-developed. The health benefits available to cats may similarly be available to other animals as well. A self-cleaning pet waste collection system may extend health benefits to other pets. Also, to appeal to pet owners, a pet waste collection system should limit owner contact with pet waste and reduce smells. A self-cleaning pet waste collection system may extend these health benefits to other pets.

### SUMMARY OF THE INVENTION

The present disclosure describes a pet waste collection system. Although the following discussion focuses on pet waste collection in the context of dogs and/or other medium sized pets, these teachings may be used in a variety of applications related to pet waste collection.

In accordance with an embodiment of the present disclosure, a pet waste collection system may include a frame, a mounting bracket, a spool, and a sensor. The frame may define a floor with a first end and a second end, and the floor may be configured to receive waste. The mounting bracket may be located on the first end of the floor and configured to receive a wrapper cartridge. The spool may be located on a second end of the floor and configured to allow a wrapper or film to be drawn from the wrapper cartridge across the floor and to roll the wrapper or film around the spool. The sensor may be configured to detect the presence of pet waste at the wrapper or film proximate the floor.

In accordance with another embodiment of the present disclosure, a wrapper for use in a pet waste collection system, may include a first layer of film and a second layer of film. The first layer of film may be configured to attract an animal to the film. The second layer of film may be configured to absorb moisture from pet waste. Further, the wrapper may be configured for use with a roller system to convey the first layer, the second layer, and pet waste onto a spool.

In accordance with a further embodiment of the present disclosure, a method for the collection of pet waste, e.g., for later disposal, may be provided. The method may include providing a frame defining a floor. The method may also positioning a portion of film across a portion of the floor and detecting the presence of pet waste on the film portion. The method may further include collecting the pet waste by gathering the pet waste and the film portion around a spool associated with the frame.

Other technical advantages will be apparent to those of ordinary skill in the art in view of the following specification, claims, and drawings.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIGS. 1A and 1B each depict selected elements of one embodiment of a pet waste collection system incorporating teachings of the present disclosure;

FIG. 2 depicts selected elements of embodiment of a pet waste collection system shown in FIG. 1 with elements removed for clarity;

FIG. 2A depicts a close-up view of selected elements shown in FIG. 2;

FIG. 3 depicts one embodiment of a wrapper cartridge including an example of a film that may be used with a pet waste collection system incorporating teachings of the present disclosure;

FIG. 4 depicts one embodiment of a spool that may be used with a pet waste collection system incorporating teachings of the present disclosure;

FIG. 5 depicts another view of the wrapper cartridge shown in FIG. 3;

FIGS. 6A and 6B each depicts a cross section view of one embodiment of a film that may be used with a pet waste collection system incorporating teachings of the present disclosure;

FIG. 7 depicts selected elements of one embodiment of a pet waste collection system with pet waste present, incorporating teachings of the present disclosure;

FIG. 8 depicts a cross-sectional view of one embodiment of a spool after collecting soiled film that may be used with a pet waste collection system incorporating teachings of the present disclosure;

FIG. 9 depicts an example method for operation of a waste collection system incorporating teachings of the present disclosure; and

FIG. 10 depicts another example method for operation of a waste collection system incorporating teachings of the present disclosure.

### DETAILED DESCRIPTION OF THE INVENTION

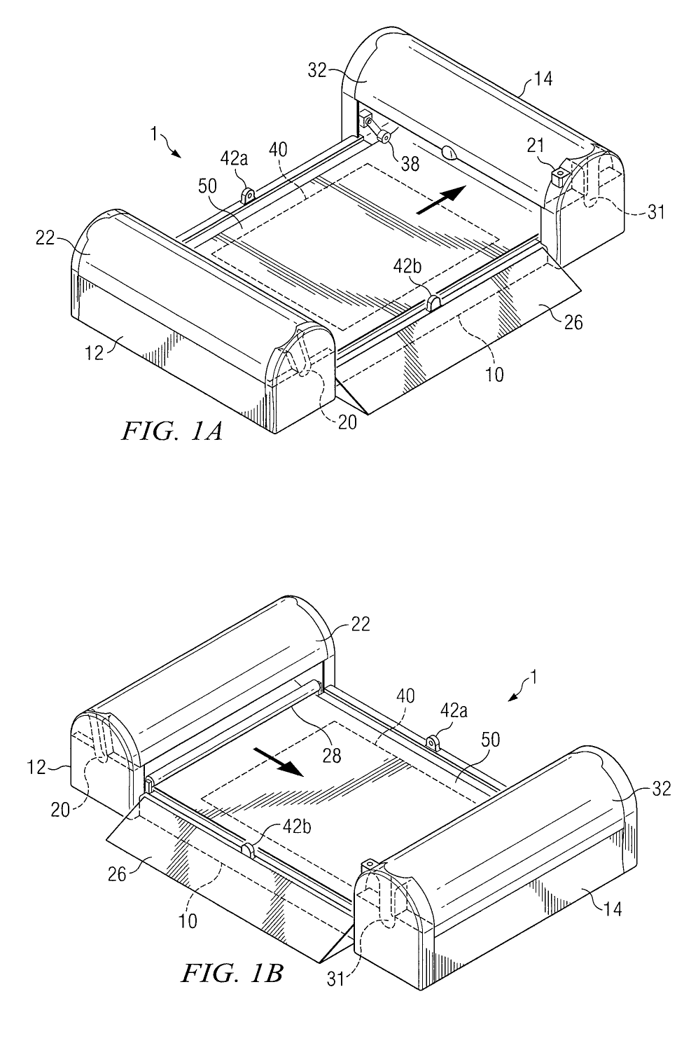

Preferred embodiments of the invention and its advantages are best understood by reference to FIGS. 1-10 wherein like numbers refer to like and corresponding parts. The exemplary implementations of pet waste collection systems presented herein may emphasize use with dogs or similarly sized pets; it should be understood, however, that the features described herein may also be appropriate for other types of animals including, as examples, birds, hamsters, gerbils, mice, rabbits, and pigs. In addition, the features described herein may be appropriate for indoor and/or outdoor use. The features described herein may also be appropriate for household use, or for use in other locations (e.g., birdcage, crate, hutch, dog house, pen). Although the disclosed embodiments have been described in detail, it should be understood that various changes, substitutions and alterations can be made to the embodiments without departing from their spirit and scope.

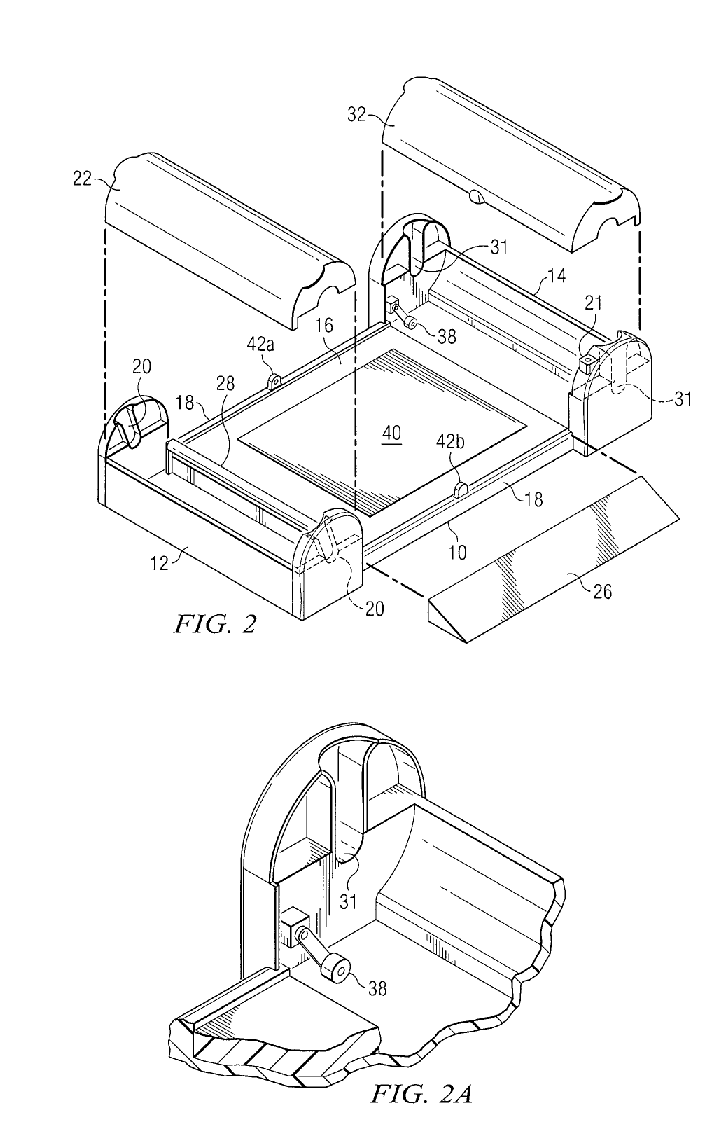

FIGS. 1A, 1B, 2, and 2A depict selected elements of one embodiment of a pet waste collection system 1 incorporating teachings of the present disclosure. FIGS. 1A and 1B show a film 50 present in pet waste collection system 1, while FIGS. 2 and 2A show pet waste collection system 1 with film 50 removed and other pieces separated or removed for clarity. In the embodiment shown, pet waste collection system 1 may include a frame 10, a mounting bracket 20, a spool bracket 31, a user interface 21, ramp 26, waste sensor 40, and animal sensor 42. Pet waste collection system 1 may be configured to offer a location for a pet or other animal to deposit liquid or solid waste. Once the animal deposits waste, pet waste collection system 1 may be configured to sense the presence of the animal and/or the deposit or presence of animal waste, collect the waste, and contain the waste under more sanitary conditions for later disposal.

Frame 10 may include a first end 12, a second end 14, a floor 16, guide rails 18, a wrapper cartridge lid 22, a spool lid 32, contact roller 28, and guide rollers 38 (one guide roller 38 is depicted; advantageously, in the embodiment shown another guide roller is be included adjacent to second end 14 and substantially opposite of the depicted guide roller 38). Frame 10 may be formed of any suitable material. For example, some selection criteria may include resistance to liquid, resistance to absorption of odor, ease of cleaning, and/or other aesthetic considerations. Frame 10 may be of any size and shape and may be adapted depending on the pet or pets intended to use pet waste collection system 1. For example, cats and/or small dogs may require less room and/or a smaller platform than large dogs. Although frame 10 as depicted in FIGS. 1A, 1B and 2 may be generally rectangular, frame 10 may be of any shape compatible with the teachings of this disclosure.

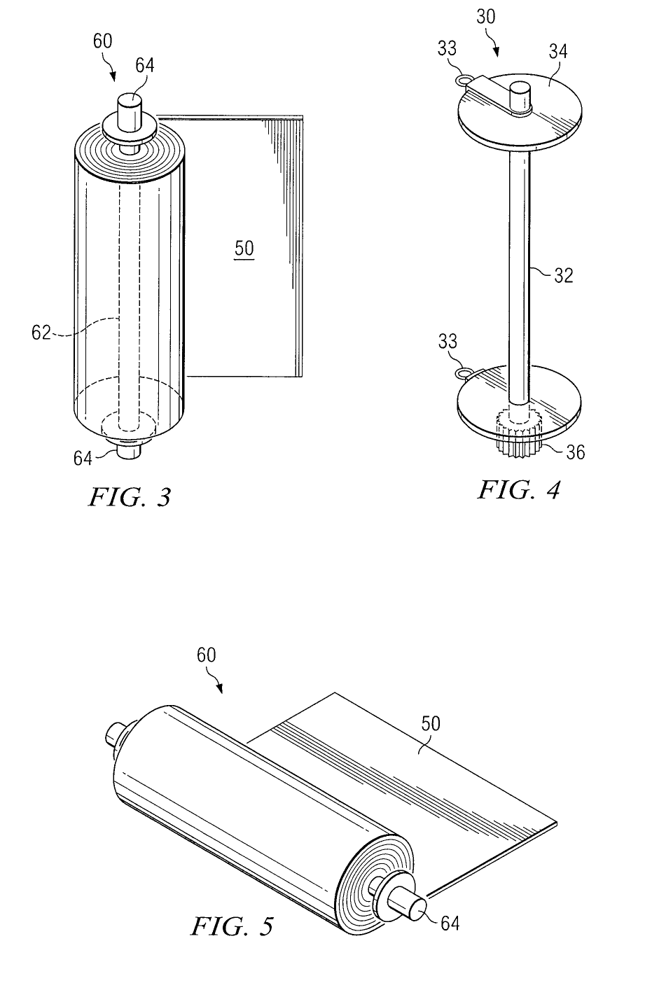

First end 12 may include one end of frame 10 and may be configured to hold or house a wrapper cartridge (one embodiment of a wrapper cartridge is shown and discussed with relation to FIGS. 3 and 5). In some embodiments, such as that shown in FIGS. 1A, 1B, and 2, first end 12 of frame 10 may identify the location of mounting bracket 20, wrapper cartridge lid 22 and contact roller 28.

Second end 14 may include one end of frame 10 distanced from and/or located opposite of first end 12. In some embodiments, such as that shown in FIGS. 1A, 1B, and 2, second end 14 of frame 10 may identify the location of spool bracket 31, spool lid 32, and guide rollers 38.

Floor 16 may include any component or feature of frame 10 configured to provide a platform for an animal to deposit waste. For instance, floor 16 may include a substantially flat expanse of material. In some embodiments, floor 16 may be configured for an animal to stand on floor 16 while eliminating waste. In other embodiments, frame 10 may be designed so that an animal may stand on another component or elsewhere (e.g., off of pet waste disposal system 1) to deposit waste. In some embodiments, floor 16 may be configured to receive waste deposited while a pet is standing on whatever surface pet waste system 1 is resting on.

Although floor 16 is shown as generally horizontal, floor 16 may be of any suitable shape and/or contour, and in some embodiments may be contoured for a particular application. For example, in some embodiments, floor 16 may be sloped across all or a part of the floor 16 or frame 10. In other embodiments floor 16 may be generally pan-shaped. Also, floor 16 may include surface or other features to enhance the operation of the pet waste collection system 1. For example, ribs may extend between first end 12 and second end 14 to serve as film guides.

Guide rails 18 are depicted. Guide rails 18 may include any device, component, and/or feature of frame 10 configured to define a portion of or boundary for floor 16. In some embodiments, guide rails 18 may be configured to guide a film 50 as it moves across floor 16. For example, as shown in FIGS. 1 and 2, guide rails 18 may include generally rectangularly-shaped bars that extend from frame 10 along the sides of floor 16. In other embodiments, guide rails 18 may include brackets that interact with some part of film 50, e.g., to held control the edges of film 50. For example, an overlapping arrangement may held hold the film edges down.

Mounting bracket 20 may include any device, component, and/or feature of pet waste collection system 1 configured to interact with a wrapper cartridge 60 for use with pet waste collection system 1 (an example of wrapper cartridge 60 is depicted in FIGS. 3 and 5). For example, mounting bracket 20 may include one or more features of frame 10 shaped to hold wrapper cartridge 60. Mounting bracket 20 may also include one or more features allowing a user of pet waste collection system 1 to load a wrapper cartridge 60 in and/or remove a wrapper cartridge 60 from pet waste collection system 1. In embodiments including wrapper cartridge 60 that include a roll of film 50, mounting bracket 20 may include features compatible with a roll of film 50, e.g., cutouts that may support a roll of film 50 while allowing the roll to unroll if film 50 is pulled. In the embodiment shown in FIGS. 1A, 1B and 2, mounting bracket 20 may include a slot with a rounded end for housing a roll of film. In other embodiments, mounting bracket 20 may include components that project into wrapper cartridge 60, similar to the types of brackets often used to mount rolls of paper towels. Mounting bracket 20 may have any suitable orientation relative to other components of pet waste collection system 1. For example, in one embodiment, mounting bracket 20 may be oriented generally perpendicular to floor 16. In another embodiment, mounting bracket 20 may be oriented at an angle not perpendicular to floor 16, such as depicted in FIG. 2, for example.

Wrapper cartridge lid 22 may include any device, component, and/or feature of frame 10 configured to cooperate with mounting bracket 20 to house wrapper cartridge 60. In some embodiments, such as that shown in FIG. 2, wrapper cartridge lid 22 may be fully removable. In other embodiments, wrapper cartridge lid 22 may be attached to first end 12 of frame 10 so that a user may open wrapper cartridge lid 22 to expose mounting bracket 20 without fully removing wrapper cartridge lid 22 from frame 10 (e.g., a living hinge).

Contact roller 28 may include any device, component, and/or feature of frame 10 configured for the control of film 50. For example, in certain embodiments, contact roller 28 may include features configured to retain film 50 against floor 16 and/or provide tension to film 50. In some embodiments, contact roller 28 may include a rolling cylinder mounted to press towards floor 16. In those embodiments, film 50 may be threaded beneath contact roller 28. As film 50 is collected (e.g., drawn across floor 16), contact roller 28 may keep film 50 in contact with floor 16, flatten film 50, and/or prevent wrinkles in film 50 without impeding the translation of film 50 across floor 16. Although contact roller 28 is depicted as a single cylindrical member in FIGS. 1B and 2, contact roller 28 may include any suitable configuration, e.g., a plurality of members (for instance, a pair of rollers between which the film passes, or one or more roller members). Contact roller 28 may be spring loaded, flexible members, rigidly mounted, or mounted to frame 10 in any suitable manner.

Spool bracket 31 may include any device, component, and/or feature of pet waste system 1 configured to hold and/or house spool 30 (one embodiment of spool 30 is shown and discussed in detail in FIG. 4). For example, spool bracket 31 may include one or more features of frame 10 shaped to hold spool 60. In the embodiment shown in FIGS. 1A, and 1B and 2, spool bracket 31 may include cutouts configured to hold a round spool 30. In other embodiments, spool bracket 31 may include features configured to hold spools 30 of various shapes. Similar to mounting bracket 20, spool bracket 31 may be adapted for ease of use in connection with the insertion and removal of spool 60, and smooth operation during spool gathering of soiled film 50.

Spool lid 32 may include any device, component, and/or feature of frame 10 configured to cooperate with spool bracket 31 to house spool 30. In some embodiments, such as that shown in FIG. 2, spool lid 32 may be fully removable. In other embodiments, spool lid 32 may be attached to second end 12 of frame 10 so that a user may open spool lid 32 to expose spool bracket 31 without fully removing spool lid 32 from frame 10 (e.g., a living hinge).

Guide rollers 38 may include any device, component, and/or feature for the control of film 50, either alone or in conjunction with frame 10. For example, in certain embodiments, guide rollers 38 may include features configured to retain film 50 against floor 16 and/or provide tension to film 50. In some embodiments, guide rollers 38 may include rolling cams mounted to press toward floor 16. In those embodiments, film 50 may be threaded beneath guide rollers 38 before it is attached to spool 30. As film 50 is collected (e.g., drawn across floor 15), guide rollers 38 may keep film 50 in contact with floor 16 without impeding the collection of film 50 on spool 30. Guide rollers 38 may be spring loaded, flexible members, rigidly mounted, or mounted to frame 10 in any suitable manner. In some embodiments, guide rollers 38 may be identical or similar to contact roller 28. Guide rollers 28 may be configured and adapted to avoid interference with waste during collection.

User interface 21 may include any system, device, and/or apparatus that allows a person to control and/or interact with pet waste collection system 1. In its simplest embodiment, user interface 21 may include an on/off switch or power button that toggles pet waste collection system 1 on and off. In the same or alternative embodiments, user interface 21 may permit a user to set and/or change operating parameters associated with pet waste collection system 1 (e.g., time delay between an animal's departure from floor 16 and operation of pet waste collection system 1, speed of film movement). Additionally, user interface 21 may include a display of information to a user (e.g., film 50 remaining in wrapper 60, amount of energy remaining in batteries, etc.). Furthermore, user interface 21 may include a momentary switch allowing a user to activate pet waste collection system 1 to take up a portion of film 50. In some embodiments, user interface 21 may be configured for receiving control signals (e.g., power on/off, move film, enter power save or sleep mode) from a remote location.

Frame 10 may be adapted to promote access to or from pet waste collection system 1, to promote stable placement of pet waste collection system 1, or to promote deposit of waste at pet waste collection system 1. For example, as shown in FIGS. 1A, 1B, and 2, pet waste collection system 1 may include a ramp coupled to frame 10. Ramp 26 may include any surface providing an incline by which a pet may enter or leave floor 16. Ramp 26 may be particularly useful for smaller breeds and/or species of animals, allowing such animals to enter and/or leave the pet waste system 1 with greater ease. In certain embodiments, ramp 26 may include a carpet and/or another feature to promote a clean use environment. In addition, although FIGS. 1A, 1B, and 2 depict only one ramp 26, pet waste collection system 1 may include any suitable number of ramps 26.

Waste sensor 40 may include any device, component, and/or feature of pet waste collection system 1 configured to sense the deposit or presence of pet waste. For example, sensor 40 may sense humidity associated with solid and/or liquid pet waste. As another example, sensor 40 may sense the weight of a pet and/or pet waste left on film 50. As another example, sensor 40 may sense a change in physical or electrical characteristics (e.g., capacitance and/or a dielectric property) of floor 16, film 50, and/or some other component of pet waste system 1 resulting from the presence of pet waste. In some embodiments, such as that shown in FIGS. 1A, 1B and 2, sensor 40 may be located on floor 16. In other embodiments, a portion of film may be adapted with sensor 40.

Animal sensor 42 may include any device, component, and/or feature of pet waste collection system 1 configured to sense the presence of a pet. For example, in some embodiments, sensor 42 may include an optical sensor wherein a light beam emitted from a source of electromagnetic radiation 42a may be detected by a photodetector 42b. In those embodiments, the presence of an animal may break the light beam, and the absence of a received signal at photodetector 42b may indicate the presence of the animal.

FIGS. 3 and 5 depict one embodiment of wrapper cartridge 60 housing a film 50 that may be used with pet waste collection system 1. In the embodiment shown, wrapper cartridge 60 may include a core 62 and two ends 64. Wrapper cartridge 60 may include any features, components, and/or devices configured to hold film 50 and dispense film 50 in cooperation with other components of pet waste system 1. For example, in embodiments like that shown in FIG. 5, film 50 may be drawn from wrapper cartridge 60 by pulling an available end or portion of film 50. Ends 64, in this embodiment, may be round, so that core 62 may rotate as film 50 is pulled. Other embodiments of wrapper cartridge 60 may provide the functions of holding and dispensing film 50 as known in the art (e.g., a roll of aluminum foil or plastic wrap, a box of tissue paper, and/or other solutions).

FIG. 4 depicts one embodiment of spool 30 that may be used with pet waste collection system 1. Spool 30 may include any device, component, and/or feature of pet waste collection system 1 configured to draw film 50 across floor 16 or otherwise collect film 50. In the embodiment shown, spool 30 may include a center 32, handles 33, an end 34, and a drive end 36. Center 32 may be any component, device, and/or feature of spool 30 configured to provide a core for wrapping film 50 as film 50 is drawn onto spool 30. Spool 30 may be configured to rest in spool bracket 31 as shown in FIGS. 1A, 1B and 2. In such embodiments, end 34 may be configured to rest in spool bracket 31 and to function as a bearing as spool 30 is rotated.

Handles 33 may be any suitable device, component, and/or feature of spool 30 configured to allow a user to remove spool 30 from spool bracket 31. For example, as depicted in FIG. 4, handles 33 comprise ring-like extensions of spool 30 that may provide a user a sanitary means to lift spool 30 from spool bracket 31 in order to discard a used roll of film 50.

Drive end 36 may include any device, component, and/or feature of spool 30 configured to rotate spool 30 in reaction to the application of a driving force. Drive end 36 may include any force transmission known in the art (e.g., a gear, a cam, a pulley and belt, etc.). In some embodiments, spool 30 may include two drive ends 36 and no end 34.

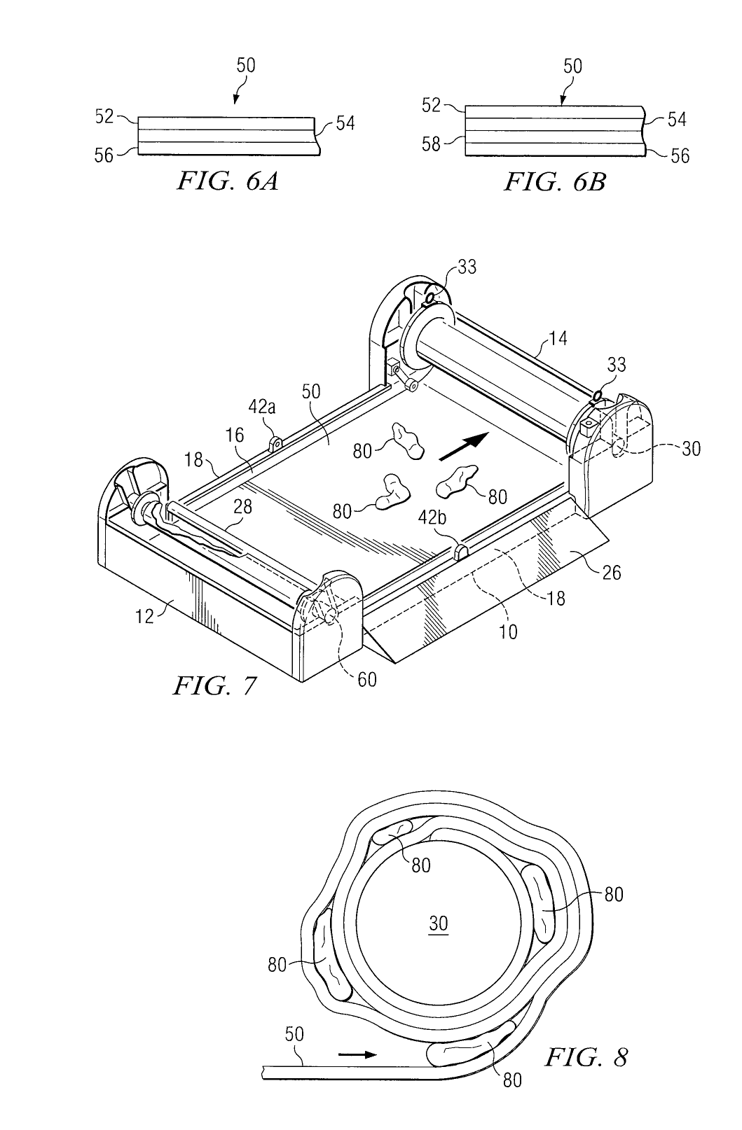

Each of FIGS. 6A and 6B depicts a cross section view of one embodiment of film 50 that may be used with pet waste collection system 1. As shown, film 50 may include one or more layers of material, components, and/or features. In certain embodiments, film 50 or one or more of its layers may comprise biodegradable material.

As depicted in FIG. 6A, film 50 may include absorbent layer 52, attraction layer 54, and resistant layer 56. Each layer may provide one or more of such functions (e.g., attraction, absorbency, imperviousness) for film 50. In the embodiment shown in FIG. 6A, absorbent layer 52 may be any material configured to absorb liquid from pet waste deposited onto film 50. Attraction layer 54 may include one or more substances and/or chemicals that give off a scent to attract an animal to pet waste collection system 1. For example, in some embodiments, attraction layer 54 may include one or more pheromones that may attract an animal to pet waste collection system 1 and/or persuade an animal to deposit waste onto film 50. In the same or alternative embodiments, attraction layer 54 may give off other scents (e.g., grass, soil, etc.) to attract an animal to pet waste collection system 1 and/or persuade an animal to deposit waste onto film 50. Resistant layer 56 may include one or more materials configured to resist transmission of pet waste from layer 52 and/or layer 54 through layer 56. Persons having ordinary skill in the art having the benefit of this disclosure will be able to implement embodiments including a variety of layers of film 50 to provide a variety of functions, of which the embodiment shown in FIG. 6A is only an example. For example, in some embodiments, film 50 may include a layer configured to reduce or eliminate odors associated with animal waste.

In the embodiment shown in FIG. 6B, film 50 may include absorbent layer 52, attraction layer 54, and resistant layer 56 such as described above with respect to FIG. 6B, and may also include sensing layer 58. Sensing layer 58 may include any devices, components, and/or features configured to sense pet waste in contact with and/or on film 50. For example, sensing layer 58 may include electrical contacts, capacitance sensors, and/or any other sensors configured to sense the presence of liquid on film 50. As another example, sensing layer 58 may include sensors configured to sense a weight of pet waste present on film 50.

Although FIGS. 6A and 6B depict film 50 with a particular number of layers in a particular configuration, film 50 may include any number of layers or a single layer, and all such layers may be an any suitable configuration or order.

In addition to having attraction layer 54, film 50 may include other features that may attract a pet to use pet waste collection system 1. For example, in some embodiments, film 50 or one or more of its layers may be textured and/or colored (e.g., textured and/or colored to appear as grass) to attract an animal.

In certain embodiments, film 50 or one or more of its layers may be textured to better absorb and/or resist pet waste. For example, a layer of film 50 (e.g., absorbent layer 52 and/or attraction layer 54) may include a texture and/or geometrical design that increases the absorbent properties of the layer. As another example, a layer of film 50 (e.g., resistant layer 56) may include a texture and/or geometrical design that resists transmission of waste onto floor 16 and/or other parts of frame 10. Film 50 may include paper, wax paper, lined paper, a form of plastic sheet, fabric, or other natural or synthetic materials, either alone or in combination. Further, such materials may be chemically or otherwise treated, or physically modified, to impose on them the physical or performance properties desired for a particular application.

As used herein, the term “layer” may refer to an inclusion of distinct material, substance, configuration, etc. to achieve a desired functional performance (e.g., absorbance, attraction, imperviousness). A layer of film need not be uniform in any particular direction, and multiple layers need not be physically separate. For example, materials may be randomly distributed in a layer to increase absorbance. Such materials may be embedded in a layer or held between multiple layers. Accordingly, a single “sheet” may include multiple layers (for example, an absorbent layer embedded within an attraction layer).

In addition, in certain embodiments, film 50 and/or wrapper 60 may include one or more devices, components, and/or features that permit pet waste collection system 1 to determine whether film 50 and/or wrapper 60 is compatible for use with pet waste collection system 1. For example, film 50 and/or wrapper 60 may include an optical identifier (e.g., a barcode and/or film surface texture/topology) that may be scanned and/or detected by pet waste collection system 1 (e.g., by an optical scanner) to determine whether the film 50 and/or wrapper 60 is properly installed and compatible with pet waste collection system 1. As another example, a metal wire may be implanted along the length of film 50. The presence of the wire may be detected by pet waste collection system 1 (e.g., by a Hall effect sensor in floor 16 or mounting bracket 20). As a further example, ends 64 of wrapper 60 may have a particular shape, such that ends 64 only engage with mounting brackets 20 having complementary shapes. In these example embodiments, operation of pet waste collection system 1 may be enabled if the film 50 and/or wrapper 60 is compatible, and may be disabled otherwise.

FIG. 7 depicts selected elements of one embodiment of pet waste collection system 1 and FIG. 8 depicts a cross-section of one embodiment of spool 30 after taking up soiled film 50 as shown in FIG. 7. The embodiment of pet waste collection system 1 includes selected components as described in relation to FIGS. 1 and 2. In addition, FIG. 7 shows pet waste 80 present on film 50 after a pet deposit on pet waste collection system 1. Pet waste collection system 1 may include components and/or devices configured to restrict the operation of spool 30 while a pet is present (e.g., sensor 42, sensing the weight of a pet standing on frame 10 and/or floor 16, etc.). In accordance with the present disclosure, sensors 40 and/or 42 may be communicatively coupled to an actuator (e.g., a motor and/or other suitable device) to activate spool 30. When spool 30 is activated, however, film 50 and pet waste 80 may be pulled across floor 16 to spool 30.

As shown in FIG. 8, film 50 may be gathered and/or rolled around spool 30. Pet waste 80 may be compressed between succeeding pieces of film 50 as it is rolled. Depending on the force applied to film 50, pet waste 80 may be compacted or otherwise shaped as film 50 is gathered around spool 30. Depending on the qualities of film 50, pet waste 80 may be dried and/or deodorized as it is gathered. In some embodiments, the edges of film 50 may be configured to seal as film 50 is gathered around spool 30. Wrapping film 50 around spool 30 may provide a compact storage option for pet waste 80 that reduces odor emission and reduces the exposure of pet waste to the atmosphere.

Film 50 may include perforations or similar features configured to allow a user to tear film 50 and remove soiled film 50 gathered around spool 30. In other embodiments, pet waste collection system 1 may include a built-in or removable device to cut or perforate film 50 as needed. In addition, a user may remove spool 30, film 50 gathered around spool 30, and any collected pet waste 80. In such embodiments, core 62 of wrapper cartridge 60 may serve as spool 30 for the next wrapper cartridge 60. In other embodiments, spool 30 may include a removable tube (like a paper towel roll) which may be removed to dispose of gathered film 50 and collected pet waste 80.

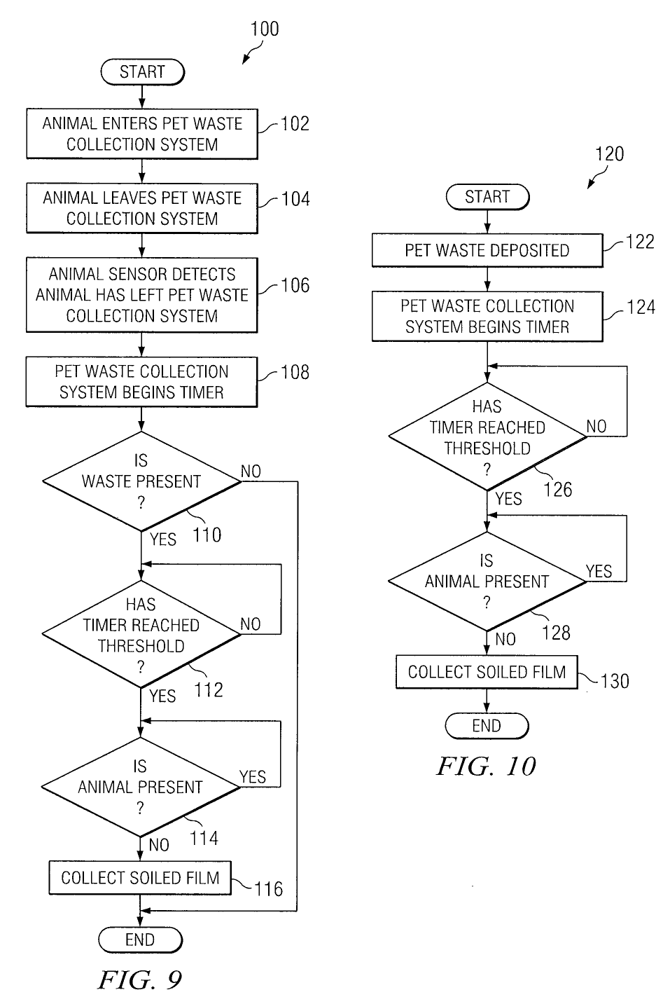

FIG. 9 depicts an example method 100 for operation of a pet waste collection system (e.g., pet waste collection system 1) incorporating teachings of the present disclosure. According to one embodiment, method 100 preferably begins at step 102. As noted above, teachings of the present disclosure may be implemented in a variety of configurations of pet waste collection system 1. As such, the preferred initialization point for method 100 and the order of the steps 102-116 comprising method 100 may depend on the implementation chosen.

At step 102, an animal may enter a pet waste collection system, (e.g., via a ramp). When the animal enters pet waste collection system, a sensor (e.g. waste sensor 40 and/or animal sensor 42) may detect the presence of the animal. For example, a sensor (e.g., waste sensor 40) may detect the weight of the animal. In the same or alternative embodiments, the animal may break a light beam emitted from a source of electromagnetic radiation (e.g., electromagnetic radiation source 42a), and the absence of light received at a photodetector (e.g., photodetector 42b) may indicate presence of the animal in the pet waste collection system.

At step 104, the animal may leave the pet waste collection system. At step 106, a sensor (e.g., animal sensor 42 and/or waste sensor 40) may detect that the animal has left the pet waste collection system. At step 108, the pet waste collection system may begin a timer in response to the detection of the animal's departure from pet waste collection system 1.

At step 110, a sensor (e.g., waste sensor 40) may detect whether or not waste is present on a film disposed in the pet waste collection system (e.g., film 50). The presence of waste may be detected by sensing humidity, weight, and/or any other suitable physical characteristic of the waste. If no waste is present, method 100 may end. Otherwise, if waste is present, method 100 may proceed to step 112.

At step 112, the pet waste collection system may determine whether the timer started at step 108 has reached a threshold. The threshold may be any suitable duration, ranging from zero to a few seconds to up to a number of minutes. The pet waste collection system may delay taking up waste until the timer has reached the threshold for any number of reasons. For example, such delay may allow an absorbent layer (e.g., absorbent layer 52) to adequately absorb moisture from the waste before it is taken up. As another example, such delay may ensure that the animal has left the pet waste collection system for a period of time, so as to not startle the animal or discourage the animal from using the pet waste collection system. Once the timer has reached the threshold, method 100 may proceed to step 114.

At step 114, a sensor (e.g., animal sensor 42 and/or waste sensor 40) may detect whether an animal is present in the pet waste collection system. Step 114 may be taken as a precaution to ensure the animal has not returned to the pet waste collection system (e.g., to deposit more waste), before taking up waste. Accordingly, if the sensor detects an animal, it may delay taking up the waste as a safety measure, to prevent startling the animal, and/or to prevent discouraging the animal from using the pet waste collection system. Once the animal is sufficiently no longer present, method 100 may proceed to step 116.

At step 116, the pet waste collection system 1 may collect the soiled film (e.g., by drawing a film across a floor to take up the waste). For example, in some embodiments, a film (e.g., film 50) may be drawn across a floor (e.g., floor 16) by a spool (e.g., spool 30). In those embodiments, a motor and/or other suitable device communicatively coupled to the sensors may drive the spool.

Although FIG. 9 discloses a particular number of steps to be taken with respect to method 100, it is understood that method 100 may be executed with greater or lesser steps than those depicted in FIG. 9. In addition, although FIG. 9 discloses a certain order of steps to be taken with respect to method 100, the steps comprising method 100 may be completed in any suitable order. Method 100 may be implemented using pet waste collection system 1 or any other system operable to implement method 100. In certain embodiments, method 100 may be implemented partially or fully in software embodied in tangible computer-readable media.

FIG. 10 depicts another example method 120 for operation of a pet waste collection system (e.g., pet waste collection system 1) incorporating teachings of the present disclosure. According to one embodiment, method 120 preferably begins at step 122. As noted above, teachings of the present disclosure may be implemented in a variety of configurations of pet waste collection system 1. As such, the preferred initialization point for method 120 and the order of the steps 122-130 comprising method 100 may depend on the implementation chosen.

At step 122, waste may be deposit at a pet waste collection system. In some embodiments, the animal may not need to enter the pet waste collection system in order to deposit waste at the pet waste collection system (e.g., the pet waste collection system may be placed at the base of a birdcage). At step 124, the pet waste collection system may begin a timer in response to the detection of the waste (e.g., a detection by waste sensor 40 that waste is present).

At step 126, the pet waste collection system may determine whether the timer started at step 124 has reached a threshold. The threshold may be any suitable duration, ranging from zero to a few seconds to up to a number of minutes. The pet waste collection system may delay taking up waste until the timer has reached the threshold for any number of reasons. For example, such delay may allow an absorbent layer (e.g., absorbent layer 52) to adequately absorb moisture from the waste before it is taken up. As another example, such delay may ensure that the animal has left the pet waste collection system for a period of time, so as to not startle the animal or discourage the animal from using the pet waste collection system. Once the timer has reached the threshold, method 120 may proceed to step 128.

At step 128, a sensor (e.g., animal sensor 42 and/or waste sensor 40) may detect whether an animal is present in the pet waste collection system. Step 128 may be taken as a precaution to ensure the animal has not returned to the pet waste collection system (e.g., to deposit more waste), before taking up waste. Accordingly, if the sensor detects an animal, it may delay taking up the waste as a safety measure, to prevent startling the animal, and/or to prevent discouraging the animal from using the pet waste collection system. Once the animal is no longer present, method 120 may proceed to step 130. Alternately, step 128 need not be performed at all in applications in which animal presence is not a concern.

At step 130, the pet waste collection system 1 may collect the soiled film (e.g., by drawing a film across a floor to take up the waste). For example, in some embodiments, a film (e.g., film 50) may be drawn across a floor (e.g., floor 16) by a spool (e.g., spool 30). In those embodiments, a motor and/or other suitable device communicatively coupled to the sensors may drive the spool.

Although FIG. 10 discloses a particular number of steps to be taken with respect to method 120, it is understood that method 120 may be executed with greater or lesser steps than those depicted in FIG. 10. In addition, although FIG. 10 discloses a certain order of steps to be taken with respect to method 120, the steps comprising method 120 may be completed in any suitable order. Method 120 may be implemented using pet waste collection system 1 or any other system operable to implement method 120. In certain embodiments, method 120 may be implemented partially or fully in software embodied in tangible computer-readable media.

Although the disclosed embodiments have been described in detail, it should be understood that various changes, substitutions and alterations can be made to the embodiments without departing from their spirit and scope.

What is claimed is:

1. A pet waste collection system, the system comprising:
a frame defining a floor with a first end and a second end, the floor configured to receive waste;
a mounting bracket located on the first end of the floor and configured to receive a wrapper cartridge;
a spool located on a second end of the floor and configured to allow a film from the wrapper cartridge to be drawn across the floor to roll the film around the spool; and
a first sensor configured to detect the presence of pet waste at the film proximate the floor.

2. The system of claim 1, wherein the sensor is configured to receive a signal from a second sensor disposed in the film.

3. The system of claim 1, wherein the sensor is located on the floor.

4. The system of claim 1, wherein the sensor senses at least one of humidity and a weight of the pet waste.

5. The system of claim 1, further comprising an actuator associated with the sensor and configured to activate the spool to draw the film across the floor and roll the film around the spool.

6. The system of claim 1, further comprising a motor configured to rotate the spool to draw the film across the floor and roll the film around the spool.

7. The system of claim 1, further comprising guide rails configured to guide the film as it is drawn across the floor.

8. The system of claim 1, further comprising a second sensor configured to detect the presence of a pet on the floor.

9. The system of claim 1, further comprising a floating shaft configured to mount the spool mounted to the frame.

10. The system of claim 1, further comprising two or more rollers adjacent the spool, the two or more rollers configured to press the film against the floor while the film is drawn across the floor.

11. The system of claim 1, further comprising one or more rollers adjacent to the mounting bracket, the one or more rollers configured to press the film against the floor while the film is drawn across the floor.

12. The system of claim 1, further comprising a safety circuit configured to detect the presence of a pet on the floor and disable the operation of the spool while a pet is present.

13. A wrapper for use in a pet waste collection system, the wrapper cartridge comprising:
a first layer of film configured to attract an animal to the film; and
a second layer of film configured to absorb moisture from pet waste;
wherein the wrapper is configured for use with a roller system to convey the first film layer, the second film layer, and pet waste onto a spool.

14. The wrapper of claim 13, further comprising a third layer of film configured to resist transmission of liquid through the wrapper.

15. The wrapper of claim 13, further comprising a fourth layer if film configured to sense the presence of pet waste.

16. The wrapper of claim 13, further comprising an identifier indicating whether the wrapper is compatible for use in a pet waste collection system.

17. A method for the collection of pet waste for later disposal, the method comprising:
providing a frame defining a floor;
positioning a portion of film across a portion of the floor;
detecting the presence of pet waste on the film portion; and
collecting the pet waste by gathering the pet waste and the film portion around a spool associated with the frame.

18. The method of claim 17, further comprising removing the spool from the frame to dispose of the film portion and the pet waste.

19. The method of claim 17, wherein detecting the presence of pet waste on the film portion includes sensing moisture in the pet waste.

20. The method of claim 17, wherein detecting the presence of pet waste on the film portion includes sensing a weight of the pet waste.
